(19) United States
(12) Patent Application Publication
(10) Pub. No.: US 2020/0203706 A1
(43) Pub. Date: Jun. 25, 2020

(54) PLASMA PROCESSING OF LITHIUM TRANSITION METAL OXIDES FOR LITHIUM ION BATTERIES

(71) Applicant: Amastan Technologies Inc., North Andover, MA (US)

(72) Inventors: Richard K. Holman, Wellesley, MA (US); Gregory Wrobel, Groveland, MA (US); Kamal Hadidi, Sudbury, MA (US)

(21) Appl. No.: 16/720,926

(22) Filed: Dec. 19, 2019

Related U.S. Application Data
(60) Provisional application No. 62/782,845, filed on Dec. 20, 2018.
(60) Provisional application No. 62/782,828, filed on Dec. 20, 2018.
(60) Provisional application No. 62/782,982, filed on Dec. 20, 2018.

(51) Int. Cl. H01M 4/04; H01M 4/139; H01M 10/0525

(52) U.S. Cl. CPC H01M 4/0469; H01M 10/0525; H01M 4/139; H01M 4/0471

(57) ABSTRACT

Disclosed herein are embodiments of a method and system for producing powders for lithium ion batteries utilizing plasma processing during the manufacture of the powders. Advantageously, embodiments of the disclosed methods can significantly reduce the manufacturing time, the overall number of steps, and the harmful byproducts of conventional lithium ion battery processing.

### INCORPORATION BY REFERENCE TO ANY PRIORITY APPLICATIONS

This application claims benefit to U.S. Provisional Patent Application Ser. No. 62/782,845, entitled “SOLID PRECURSORS FOR LITHIUM ION BATTERY CATHODE MATERIAL,” filed on Dec. 20, 2018, U.S. Provisional Patent Application Ser. No. 62/782,828, entitled “TWO-STEP MICROWAVE PLASMA PRODUCTIONS OF LITHIUM TRANSITION METAL OXIDES FOR LITHIUM ION BATTERIES,” filed Dec. 20, 2018, and U.S. Provisional Patent Application Ser. No. 62/782,982, entitled “SINGLE STEP PLASMA PRODUCTIONS OF LITHIUM TRANSITION METAL OXIDES,” filed on Dec. 20, 2018, the contents of each of which are hereby incorporated by reference in their entireties.

### STATEMENT REGARDING FEDERALLY SPONSORED R&D

The invention was made with government support from the Department of Energy under the SBIR Phase I/Phase II grant. The government has certain rights in the invention.

### BACKGROUND

### Field

The present disclosure relates to techniques for preparing solid precursors for battery materials, and more specifically to techniques for generating lithium ion (Li-ion) battery materials.

### SUMMARY

Disclosed herein are embodiments of a method of preparing cathode powders for use in a cathode of a lithium ion cell, the method comprising providing raw materials of metallic salts comprising lithium dissolved in a solvent, mixing the raw materials to form a feedstock material, and plasma processing the feedstock material to produce a micron or smaller sized solid powder, the solid powder having all or part of NMC constituent materials. wherein no thermal post-processing is performed after the plasma processing.

In some embodiments, the method can further comprise adding a dopant material into the raw materials. In some embodiments, dopant material is selected from the group consisting of Al, Mg, Zr, Ti, Zn, F, P, V, Cr, Nb, and K. In some embodiments, dopant material is selected from the group consisting of Al, Mg, Zr, and Ti.

In some embodiments, the solid powder has a d50 particle size of 5-15 μm, a d10 of 1-2 μm, and a d90 of 25-40 μm. In some embodiments, the solid powder comprises particles having a d50 diameter of less than 500 nm. In some embodiments, the solid powder comprises particles having a d50 diameter of between 0.5 μm and 30 μm.

In some embodiments, the method can further comprise feeding the feedstock material into a droplet maker prior to the microwave plasma processing. In some embodiments, the metallic salts further include cobalt, nickel, manganese, aluminum, and combinations thereof. In some embodiments, the plasma processing is microwave plasma processing.

In some embodiments, the method does not use co-precipitation. In some embodiments, lithium is not added into the solid powder after the plasma processing.

In some embodiments, the method takes from 4-8 hours. In some embodiments, the method takes under 10 hours. In some embodiments, the method takes under 6 hours.

The method of any one of Claims 1-13, wherein the metallic salts are selected from the group consisting of nitrates, acetates, hydroxides, chlorides, sulfates, and carbonates.

Also disclosed herein are embodiments of a method of preparing cathode powders for use in a cathode of a lithium ion cell, the method comprising providing raw materials of metallic salts comprising lithium dissolved or dispersed in a solvent, mixing the raw materials to form a raw material mixture, spray drying the raw material mixture to form a resulting solid feedstock material, and plasma processing the feedstock material to produce a nanosized solid powder, the solid powder having all of NMC constituent materials, wherein no thermal post-processing is performed after the plasma processing.

In some embodiments, the method can further comprise adding a dopant material into the raw materials. In some embodiments, dopant material is selected from the group consisting of Al, Mg, Zr, Ti, Zn, F, P, V, Cr, Nb, and K. In some embodiments, dopant material is selected from the group consisting of Al, Mg, Zr, and Ti.

In some embodiments, the solid powder comprises particles having a d50 diameter of less than 500 nm. In some embodiments, the method further comprises feeding the feedstock material into a droplet maker prior to the microwave plasma processing. In some embodiments, the metallic salts further include cobalt, nickel, manganese, aluminum, and combinations thereof. In some embodiments, the plasma processing is microwave plasma processing.

In some embodiments, the method does not use co-precipitation. In some embodiments, lithium is not added into the solid powder after the plasma processing.

In some embodiments, the method takes from 4-8 hours. In some embodiments, the method takes under 10 hours. In some embodiments, the method takes under 6 hours.

In some embodiments, the metallic salts are selected from the group consisting of nitrates, acetates, hydroxides, chlorides, sulfates, and carbonates.

Further disclosed herein are embodiments of a method of preparing powders for use in a cathode of a lithium ion cell, the method comprising providing raw materials of metallic salts comprising lithium dissolved in a solvent, mixing the raw materials to form a feedstock material, plasma processing the feedstock material to produce a NMC precursor powder, and calcining the NMC precursor powder to form calcined NMC powder, wherein lithium is not added during the calcining.

In some embodiments, the method can further comprise mixing the NMC precursor powder with a liquid to form a slurry and spray drying the slurry prior to the calcining. In some embodiments, the calcining occurs from 1-12 hours at a temperature of 700-1000° C.

In some embodiments, the method can further comprise adding a dopant material into the raw materials. In some embodiments, the dopant material is selected from the group consisting of Al, Mg, Zr, Ti, Zn, F, P, V, Cr, Nb, and K. In some embodiments, the dopant material is selected from the group consisting of Al, Mg, Zr, and Ti.

In some embodiments, the calcined NMC powder has a d50 particle size of 5-15 μm, a d10 of 1-2 μm, and a d90 of 25-40 μm. In some embodiments, the calcined NMC powder comprises particles having a d50 diameter of less than 500 nm. In some embodiments, the calcined NMC powder comprises particles having a d50 diameter of between 0.5 μm and 30 μm.

In some embodiments, the method can further comprise feeding the feedstock material into a droplet maker prior to the microwave plasma processing. In some embodiments, the metallic salts further include cobalt, nickel, manganese, aluminum, and combinations thereof. In some embodiments, the plasma processing is microwave plasma processing.

In some embodiments, the method does not use co-precipitation. In some embodiments, lithium is not added into the NMC precursor powder after the plasma processing.

In some embodiments, the method takes from 4-8 hours. In some embodiments, the method takes under 10 hours. In some embodiments, the method takes under 6 hours.

In some embodiments, the metallic salts are selected from the group consisting of nitrates, acetates, hydroxides, chlorides, sulfates, and carbonates.

Also disclosed herein are embodiments of a method of preparing powders for use in a cathode of a lithium ion cell, the method comprising providing molten metallic salts comprising lithium, and plasma processing the molten metallic salts to produce a micron or smaller sized solid cathode powder, the solid powder having all of NMC constituent materials, wherein no thermal post-processing is performed after the plasma processing.

In some embodiments, the solid powder has a d50 particle size of 5-15 μm, a d10 of 1-2 μm, and a d90 of 25-40 μm. In some embodiments, the solid powder comprises particles having a d50 diameter of less than 500 nm. In some embodiments, the solid powder comprises particles having a d50 diameter of between 0.5 μm and 30 μm.

In some embodiments, the molten metallic salts further include cobalt, nickel, manganese, aluminum, and combinations thereof. In some embodiments, the plasma processing is microwave plasma processing.

In some embodiments, the method does not use co-precipitation. In some embodiments, lithium is not added into the solid powder after the plasma processing.

In some embodiments, the method takes from 4-8 hours. In some embodiments, the method takes under 10 hours. In some embodiments, the method takes under 6 hours.

In some embodiments, the molten metallic salts are selected from the group consisting of nitrates, acetates, hydroxides, chlorides, sulfates, and carbonates.

Also disclosed herein are embodiments of a lithium ion cell formed from the methods disclosed herein. Further disclosed herein are embodiments of a battery formed from the lithium ion cell disclosed herein.

Disclosed herein are embodiments of a method of preparing a solid precursor for use in a lithium ion battery, the method comprising providing precursor materials comprising metallic salts having lithium, nickel, manganese, and cobalt dissolved in a solvent, mixing the precursor materials to form a feedstock material, and microwave plasma processing the feedstock material to produce a solid precursor product, the solid precursor product having all or part of NMC constituent materials.

In some embodiments, the method can further comprise calcining the solid precursor product at a particular time and temperature to form an electroactive material. In some embodiments, lithium is not added during the calcining. A lithium ion battery including a calcined solid precursor produced by embodiments of the disclosure.

In some embodiments, further comprising mixing the solid precursor product into a slurry, spray drying the slurry, and calcining the spray dried slurry at a particular time and temperature to form an electroactive material. In some embodiments, the method can take from 4-8 hours. In some embodiments, the solid precursor product can comprise particles in the nano or micron scale. In some embodiments, the lithium can be incorporated at a molecular scale in the precursor materials product. In some embodiments, the metallic salts can be selected from the group consisting of nitrates, acetates, hydroxides, chlorides, sulfates, and carbonates.

In some embodiments, the solid precursor product can comprise particles having a d50 diameter of less than 500 nm. In some embodiments, the solid precursor can comprise particles having a d50 diameter of between 0.5 μm and 30 μm.

In some embodiments, sulfur and sodium are not included in the solid precursor. In some embodiments, the solid precursor may not be washed to remove contaminants.

Further disclosed herein are embodiments of a method of preparing a solid precursor product for use in a lithium ion battery, the method consisting of providing precursor materials comprising metallic salts having lithium, nickel, manganese, and cobalt dissolved in a solvent, mixing the precursor materials to form a feedstock material, microwave plasma processing the feedstock material to produce a solid precursor product, the solid precursor product having all or part of NMC constituent materials, and calcining the solid precursor product at a particular time and temperature to form an electroactive material.

Also disclosed herein are embodiments of a method of preparing a solid precursor product for use in a lithium ion battery, the method consisting of providing precursor materials comprising metallic salts having lithium, nickel, manganese, and cobalt dissolved in a solvent, mixing the precursor materials to form a feedstock material, microwave plasma processing the feedstock material to produce a solid precursor product, the solid precursor product having all or part of NMC constituent materials, mixing the solid precursor into a slurry, spray drying the slurry, and calcining the spray dried slurry at a particular time and temperature to form an electroactive material.

Disclosed herein are embodiments of a method of preparing a solid material for use in a lithium ion battery, the method comprising providing starting precursor materials comprising lithium, nickel, manganese, and cobalt salts, dissolving and mixing the starting precursor materials to form a resulting feedstock material, microwave plasma processing the resulting feedstock material to produce a particulate product, and calcining the particulate product at a particular temperature and period of time to produce a layered NMC crystal structure.

In some embodiments, the layered NMC crystal structure can be formed from the starting precursor materials in under 10 hours. In some embodiments, the layered NMC crystal structure can be formed from the starting precursor materials in under 6 hours. In some embodiments, the calcining can occur from 1-12 hours at a temperature of 700-1000° C. In some embodiments, the layered NMC crystal structure can be an α-NaFeO₂ crystal structure with alternating atomic layers of lithium and transition metal oxides.

In some embodiments, the starting precursor materials can further comprise dopant materials. In some embodiments, the dopant materials can be selected from the group consisting of Al, Mg, Zr, Ti, Zn, F, P, V, Cr, Nb, and K.

In some embodiments, the layered NMC crystal structure can have a d50 particle size of 5-15 μm, a d10 of 1-2 μm, and a d90 of 25-40 μm. In some embodiments, the layered NMC crystal structure can have a composition LiₐNiₓCo_{y}Mn_{z}M1_{d1}M2_{d2}O₂, where a=0.8−1.3, x+y+z=1−d1−d2, M1=cationic dopant #1, M2=cationic dopant #2, d1=concentration of dopant #1, and d2=concentration of dopant #1.

In some embodiments, the method can further comprise sieving/classifying the layered NMC crystal structure.

In some embodiments, the method can further comprise forming a slurry from the particulate product and spray drying the slurry prior to the calcining. In some embodiments, the method can further comprise feeding the resulting feedstock material into a droplet maker prior to the microwave plasma processing. In some embodiments, the starting precursor materials can further comprise chlorides, sulfates, acetates, and/or nitrates dissolved in deionized water or an appropriate solvent. In some embodiments, the microwave plasma processing can occur in an environment comprising oxygen or oxygen in combination with argon, helium, hydrogen, or nitrogen. In some embodiments, the crystallized material can be NMC 811 or NMC 532.

Disclosed herein are embodiments of a method of forming a crystallized material, the method comprising providing starting materials comprising lithium, nickel, manganese, and cobalt salts, providing dopant materials, the dopant materials configured to make a surface of the crystallized material less reactive or by stabilizing a structure of the crystallized material against degradation from electrochemical cycling, dissolving and mixing the starting materials and the dopant materials to form a resulting feedstock material, microwave plasma processing the resulting feedstock material to form the crystallized material, and harvesting the crystallized material, the crystallized material comprising an oxide compound made of lithium, nickel, manganese, and cobalt.

In some embodiments, the resulting feedstock material can be a liquid. In some embodiments, the resulting feedstock material can be a solid, such as a spray dried feedstock.

In some embodiments, the method can further comprise feeding the resultant feedstock material is finely dispersed into a carrier gas and fed into the microwave plasma processing. In some embodiments, the starting materials can be selected from the group consisting of chlorides, fluorides, carbonates, hydroxides, sulfates acetates, nitrates, phosphates, formates, azides, cyanides, amides, leates, propionates, butyrates, caprylates, lactates, benzoates, stearates, malonates, succinates, citrates, glutarates, and carboxylates, dissolved or dispersed in deionized water or an appropriate solvent or blend of solvents. In some embodiments, the microwave plasma processing can occur in an environment comprising oxygen or oxygen in combination with argon, helium, hydrogen, or nitrogen. In some embodiments, the dopant material can be selected from the group consisting of Al, Zr, Zn, Mg, F, Ti, Cr, V, and P.

In some embodiments, the crystallized material can be NMC 622. In some embodiments, the crystallized material can be NMC 811. In some embodiments, the crystallized material can be NMC XYZ, wherein the precursor material has the composition LiₐNiₓMn_{y}Co_{z}O₂ where Ni>0.8, x+y+z=1, and a=0.8 to 1.3. In some embodiments, the precursor material can have the composition LiₐNiₓMn_{y}Co_{z}M1_{d1} M2_{d2} . . . Mm_{dm}O₂ where a=0.8-1.3, M1=cationic dopant #1, M2=cationic dopant #2, Mₘ=cationic dopant # m, d1=concentration of dopant #1, d2=concentration of dopant #2, dm=concentration of dopant m, x+y+z=1, 0≤x≤1, 0≤y≤1, and 0≤z≤1.

In some embodiments, no thermal post-processing may be performed after the microwave plasma processing.

Also disclosed herein are embodiments of a method of forming a lithium ion battery material, the method comprising providing starting materials comprising lithium, nickel, manganese, and cobalt salts, providing dopant materials, the dopant materials configured to make a surface of the crystallized material less reactive or by stabilizing a structure of the crystallized material against degradation from electrochemical cycling, dissolving and mixing the starting materials and the dopant materials to form a resulting feedstock material, microwave plasma processing the resulting feedstock material to form the lithium ion battery material, and harvesting the lithium ion battery material comprising an oxide compound made of lithium, nickel, manganese, cobalt and the dopant materials.

In some embodiments, the lithium ion battery material can be crystalline.

Disclosed herein are embodiments of a method of forming a lithium ion battery material, the method comprising providing starting materials comprising lithium, nickel, manganese, and cobalt salts, dissolving and mixing the starting materials to form a resulting feedstock material, microwave plasma processing the resulting feedstock material to form the lithium ion battery material, and harvesting the lithium ion battery material comprises an oxide compound made of lithium, nickel, manganese, and cobalt.

Disclosed herein are embodiments of a crystallized material formed from the disclosure.

Further disclosed herein are embodiments of a lithium ion battery comprising the crystallized material formed from the disclosure.

Also disclosed are embodiments of a lithium ion battery including the layered NMC crystal structure produced from the disclosure as a portion of a cathode.

Further disclosed herein are embodiments of a layered NMC crystal structure formed from the disclosure.

Disclosed herein are embodiments of a lithium ion battery including the solid precursor product formed from the disclosure as a portion of a cathode.

Disclosed herein are embodiments of a solid precursor product formed from the disclosure.

### BRIEF DESCRIPTION OF THE DRAWINGS

FIG. 1 shows an example of a co-precipitation method known in the art.

FIGS. 2A-2C show example embodiments of improved manufacturing methods disclosed herein.

FIGS. 3A-3B show example embodiments of improved manufacturing methods disclosed herein.

FIGS. 4A-4B are scanning electron microscope (SEM) pictures of embodiments of solid nano-scale and micron scale nickel-manganese-cobalt (NMC) precursors formed from the disclosure.

FIG. 5 is a scanning electron microscope (SEM) picture of an embodiment of a single crystal nickel-manganese-cobalt (NMC) 811 formed from the disclosure, in particular the process described with respect to FIG. 3A.

FIGS. 6A-6B illustrate scanning electron microscope (SEM) pictures of particles produced by embodiments of the disclosure.

FIG. 7 illustrates an embodiment of a method for tailoring lithium-ion battery materials.

FIG. 8 illustrates electrical performance data of NMC 532 produced from embodiments of the disclosure.

FIG. 9 illustrates electrical performance data of NMC 622 produced from embodiments of the disclosure.

### DETAILED DESCRIPTION

Disclosed herein are embodiments of a solid precursor containing lithium powders for use in lithium ion batteries and battery cells, as well as methods of manufacturing the solid precursor. The powders can be NMC materials, such as including layered NMC crystal structures. In some embodiments, the solid precursor can have reduced contaminants or be contamination-free. Further, the solid precursor can be significantly cheaper and faster to produce than the standard co-precipitation, reducing costs of production, and can eliminate the need for the utilization of large amounts of water.

As discussed herein, a solid precursor can be defined as a powder or particulate matter that has all or part of the NMC constituent materials. In some embodiments, once they are calcined at the right temperature and for the right period of time, they form electroactive material with all the elemental constituents and the desired crystallographic structure. In some embodiments, calcining is not needed to form the electroactive materials.

Specifically, disclosed herein are methodologies, systems, and apparatus for producing lithium-containing particles and Li-ion battery materials. Cathode materials for Li-ion batteries can include lithium-containing transition metal oxides, such as, for example, LiNiₓMn_{y}Co_{z}O₂ or LiNiₓCo_{y}Al_{z}O₂, where x+y+z equals 1 (or about 1). These materials may contain a layered crystal structure where layers of lithium atoms sit between layers of transition-metal oxide polyhedra. However, alternative crystal structures can be formed as well, such as spinel type crystal structures. As Li-ions deintercalate from the crystal structure, charge neutrality is maintained with an increase in the valence state of the transition metals. LiNiₓMn_{y}Co_{z}O₂ or LiNiₓCo_{y}Al_{z}O₂ possess desirable characteristics such as relatively high energy density (mAh/g), high cyclability (% degradation per charge/discharge cycle), and thermal stability (≤100° C.).

Different metallic precursor salts can provide different final products. For example, lithium and cobalt salts can be used to produced LCOs. Lithium and nickel salts can be used to prepare LNOs. Lithium and manganese salts can be used to prepare LMOs. Lithium, nickel, and manganese salts can be used to prepare LNMOs. Lithium, nickel, cobalt, and aluminum salts can be used to prepare LNCAs. Lithium, nickel, manganese, cobalt, and aluminum salts can be used to prepare LNMCAs. The starting precursor metallic salts are not limiting.

Various characteristics of the final lithium-containing particles, such as porosity, particle size, particle size distribution, phase composition and purity, microstructure, etc. can be tailored and controlled by fine tuning various process parameters and input materials. In some embodiments, these can include precursor solution chemistry, droplet size, plasma gas flow rates, plasma process gas choice, residence time of the droplets within the plasma, quenching rate, power density of the plasma, etc. These process parameters can be tailored, in some embodiments, to produce micron and/or sub-micron scale particles with tailored surface area, a specific porosity level, low-resistance Li-ion diffusion pathway, a narrow size distribution of about ±2%, and containing a micro- or nano-grain microstructure.

### Lithium Ion Batteries

Lithium ion batteries are widely used and are ubiquitous in everyday life. They are widespread in consumer electronics, electric vehicles, cordless power tools, electric unmanned aerial vehicles, electric robots and more.

Each application places unique energy and power density requirements on the battery. For example, consumer electronics generally require high capacity with low power output allowing for long battery life. On the other hand, cordless power tools require high power output without stringent energy density requirements. To meet the specific requirements required from each application listed above batteries are specifically designed. As part of the design, specific characteristics of the cathode material within the battery require special attention.

As portable electronic devices steadily decrease in size, the need for smaller and lighter batteries that can provide power to these devices increases. Demand for higher energy batteries is also increasing in the field of hybrid and fully electric vehicles. Such vehicles can improve air quality by reducing air pollution and vehicular emissions caused by traditional combustion engines. Rechargeable Li-ion batteries can be used in both consumer electronics and electric vehicle applications. However, expensive and complicated manufacturing processes continue to contribute to the high cost of lithium-containing materials commonly used in Li-ion batteries and the Li-ion batteries.

Li-ion batteries generally contain a negative electrode, known as an anode, a positive electrode, known as a cathode, a separator material between the cathode and anode that is typically a porous membrane, and an electrolyte to transfer ions between the two electrodes. During charging, Li-ions (Li+) migrate from the cathode through the electrolyte and enter the structure of the anode via intercalation or conversion (crystal structure change or alloying), taking up sites between atomic layers, within the crystal structure, converting the lattice to a new crystal structure, by forming an alloy, etc. Graphite can be used as an intercalation compound for the anode because the Li-ions can be embedded within the van der Waals gap between layers of the graphite, where they are stored until discharge. An organic solution including a lithium salt or Li-ion conducting polymer can be used as the electrolyte, in some cases.

The cathode material in high energy batteries are generally made with a relatively small particle size and high surface area to allow Li⁺ ions quickly move in and out of the material upon charge and discharge. Otherwise, Li⁺ ions may not be able to fast enough to keep up with the power demand.

In Li-ion batteries, materials, such as single-phase materials, containing appropriate amounts of lithium transition metal oxide are desirable for the cathode, or positive electrode. Examples of single-phase materials include LiNi_{0.8}Co_{0.2}O₂, LiCoO₂, LiNiₓMn_{y}Co_{z}O₂ or LiNiₓCo_{y}Al_{z}O₂. Examples of multi-phase materials are the so-called “layered-layered-spinel” cathode (e.g. xLi₂MnO₃.(1-x)LiMO₂ where M=Mn, Ni, Co and lithium and manganese rich metal oxide cathodes. Specifically, with respect to LiNiₓMn_{y}Co_{z}O₂, varying the content ratio of manganese, nickel, and cobalt can tune the power and energy performance of a battery. However, the production of these transition metal oxides can require time and energy consuming processing steps, such as long and potentially energy intensive synthesis processes for either the precursors or final materials, calcination, washing, mixing, size reduction processes, classification, etc. In some cases, alkaline solutions are used in one or more initial processing steps, which can produce unwanted by products. The complexity of such processes contributes to the high cost of Li-ion batteries. In addition, tailoring or optimizing dopants can be difficult and may require additional processing steps to incorporate into the host material.

### Lithium Ion Battery Production

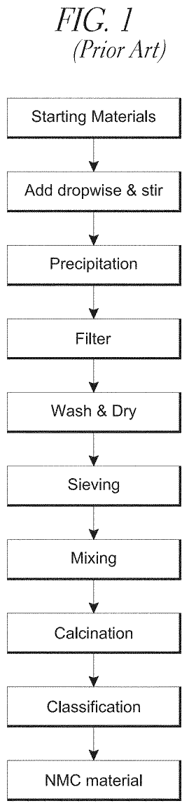

FIG. 1 depicts an example embodiment flow diagram of the co-precipitation method known in the art. Co-precipitation is the traditional method to produce many common materials used in Li and Li-ion batteries, such as NMC and related cathodes.

In the co-precipitation method, the process starts with mixing the chemical precursors in a very controlled way and stirring them. This process requires tight control of temperature, pH and stir time. The chemicals are stirred for 4-35 hours before the precipitation is complete. A wet precipitate is then extracted and filtered. Due to the use of sulfates and sodium hydroxide in the precursor, the precipitate is contaminated with sulfur and sodium which both need to be removed by multiple washing operations. This process generates waste water that needs to be disposed of in a safe way. After the precipitate is washed, it is sieved to remove any large lumps. Up to this stage, the powder produced is referred to as the NMC solid precursor. This powder precursor material is then mixed with lithium carbonate or lithium hydroxide and calcined at a specific temperature to produce NMC layered material with the desired stoichiometry.

Thus, this co-precipitation production method does have limitations. Co-precipitation based methods require multiple lengthy steps, consume a large amount of water to wash the precipitate, and generate a large amount of waste that need to be disposed of. The washing is performed multiple times to remove unwanted materials, such as sodium and sulfur that are present in the co-precipitation liquid precursor chemistry. In addition, co-precipitation produces materials that do not contain lithium, which is added in an additional step after the co-precipitate product is washed and dried. In addition, it may be difficult to add particular dopants to the material. This method relies on lithium diffusing into the co-precipitate product during a calcination step and requires relatively high temperatures and long calcination time to allow diffusion of lithium into the bulk. Further, the processing can take multiple days from start to final product, the solid precipitate.

Also, as mentioned the solid precursor produced through co-precipitation method does not contain lithium and necessitates an additional lithiation step by adding a lithium compound to the precursor and further calcining the mixture at the right temperature. The process of incorporating lithium into the precursor material happens through diffusion of lithium into the bulk of the precursor particles. This necessitates high temperatures (700-1000° C.) and long calcining time, typically 10 hours or more.

Accordingly, for the conventional batch processing technique, an amount of starting materials must undergo a number of discrete processing steps, requiring different machinery and chemical reactions. These steps can include, for example, stirring, precipitation, filtering, washing, drying, sieving, mixing, calcination, classification, and coating before a slurry can be formed. Such techniques can take up to days to complete for each batch of starting materials.

Further, solid-state processes for producing lithium-containing particles are generally multi-step processes requiring the crushing of stoichiometric proportions of precursors, followed by high temperature diffusion reaction to form the final structure. Such processes often produce large and irregularly shaped particles that may exhibit phase inhomogeneity and a broad size distribution Which can lead to poor particle packing in the electrode, non-optimal specific surface area, difficulty in slurry and electrode processing, and degraded performance. Post-processing reduction of particle size is often required to decrease the particle size to minimize the Li-ion diffusion pathway length, which increases the risk of contaminants.

Synthesis of, for example, LiNi_{1/3}Mn_{1/3}Co_{1/3}O₂ through co-precipitation is conventionally a multi-step process involving solution reaction of NiSO₄, CoSO₄, and MnSO₄. The resulting (Ni_{1/3}Mn_{1/3}Co_{1/3})(OH)₂ is dried, followed by reaction with LiOH*H₂O at elevated temperature, and then calcination at between 800-1000° C. for up to about 10 or more hours. The resulting powders have a broad size distribution. The chemical waste solution contains sulfites and strong bases which require special handling and disposal which increases cost.

Spray pyrolysis techniques may also be used to synthesize Li-ion cathode materials. An example spray pyrolysis method can be used to synthesize LiNi_{1/3}Mn_{1/3}Co_{1/3}O₂ starting with an aqueous precursor solution of LiNO₃, Ni(NO₃), Co(NO₃)₂, and Mn(NO₃)₂. The precursor solution is atomized using an ultrasonic atomizer and exposed to 2500° C. using a furnace or flame where the precursor solution is evaporated and decomposed into the desired LiNi_{1/3}Mn_{1/3}Co_{1/3}O₂ particles. The thermal profile in conventional spray pyrolysis typically has large temperature gradients, contributing to variation in thermal history experienced by the resulting particles and thus product non-uniformity. In addition, flame-based methods result in combustion products that may be incorporated in the resulting material.

### Expedited Precursor Processing

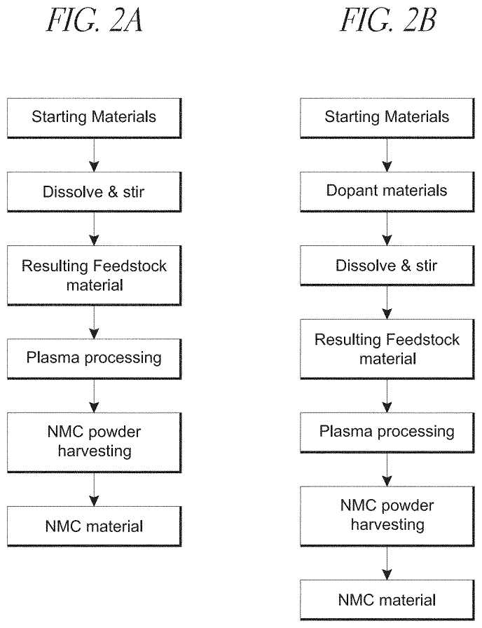

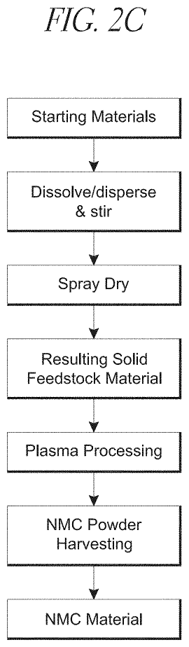

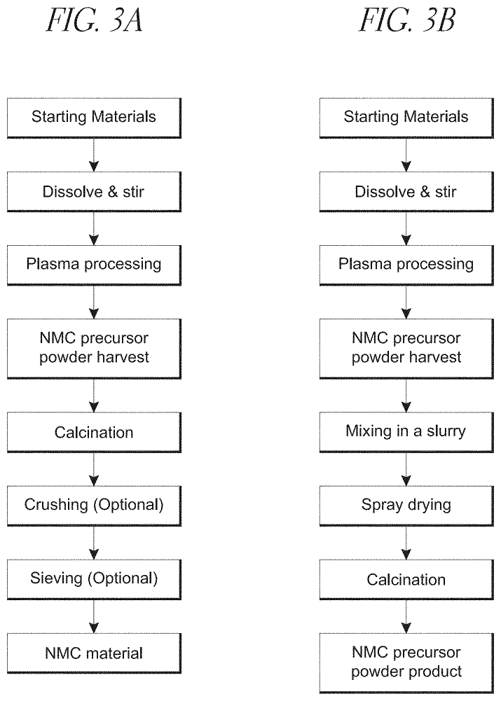

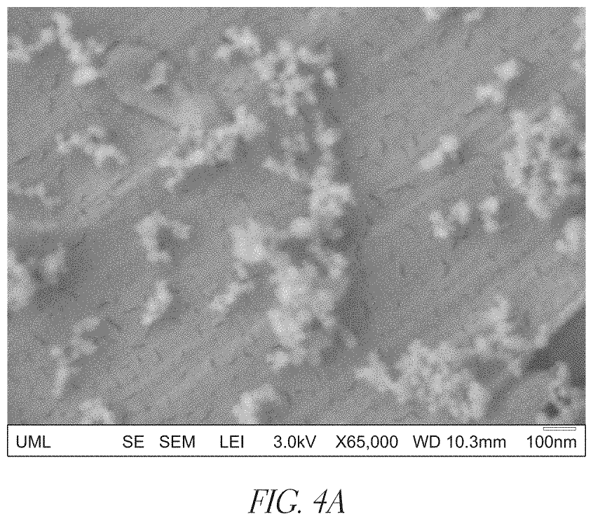

FIGS. 2A-2C and 3A-3B illustrate embodiments of expedited precursor processing methods. Elements discussed with respect to FIGS. 2A-2C can be incorporated into the process of FIGS. 3A-3B and vice versa.

In some embodiments, any of the methods disclosed herein do not require one or more of co-precipitation, filtering, or washing/drying, all of which are required in the method of FIG. 1. Further, in embodiments of the disclosure the methods do not require lithium to be added to any powder as a separate step requiring subsequent thermal processing. In some embodiments, calcination is not required, though other embodiments may use calcination.

FIG. 2A describes a first process. As shown, starting raw materials can be collected and dissolved/stirred/mixed with a solvent to form a liquid feedstock material. This feedstock material can then be processed using plasma processing to form a powder, which then can be used in battery cells. Further details are disclosed below.

FIG. 2B describes a second process. As shown, starting raw materials can be collected and dissolved/stirred/mixed with a solvent to form a liquid feedstock material. Additionally, dopant(s) can be added into the liquid feedstock material. This feedstock material can then be processed using plasma processing to form a powder, which then can be used in battery cells. Further details are disclosed below.

FIG. 2C describes a third process. As shown, starting raw materials can be collected and dissolved/stirred/mixed with a solvent to form a liquid feedstock material. The liquid feedstock material can then be dried, such as by spray drying, to form a solid feedstock material. This feedstock material can then be processed using plasma processing to form a powder, which then can be used in battery cells. Dopants can be added into either the liquid or solid feedstock. Further details are disclosed below.

FIG. 3A describes a fourth process. As shown, starting raw materials can be collected and dissolved/stirred/mixed with a solvent to form a liquid feedstock material. Additionally, dopant(s) can be added into the liquid feedstock material. This feedstock material can then be processed using plasma processing to form a powder. This powder can then be calcined into further electroactive powders. Optionally, crushing and or sieving can be performed after the calcination. Dopants can be added into the liquid feedstock material in some embodiments. Further details are disclosed below.

FIG. 3B describes a fifth process. As shown, starting raw materials can be collected and dissolved/stirred/mixed with a solvent to form a liquid feedstock material. Additionally, dopant(s) can be added into the liquid feedstock material. This feedstock material can then be processed using plasma processing to form a powder. The powder can be mixed with a liquid to form a slurry, and then dried such as through spray drying. This dried powder can then be calcined into further electroactive powders. Optionally, crushing and or sieving can be performed after the calcination. Dopants can be added into the liquid feedstock material in some embodiments. Further details are disclosed below.

The methods disclosed can produce nano or micron sized powder (such as NMC powder) which can be completed on a scale of hours, rather than days. Specifically, the process allows for lithium containing transition metal oxides to be made in minimized processing steps by introducing liquid or solid precursor into a plasma process, discussed below, where the microwave generated plasma, or other types of plasma, transforms the precursor into a well crystallized material with the appropriate structure as defined by the chemistry and x-ray diffraction analysis without the need for thermal post processing after plasma processing, such as calcining, in FIGS. 2A-2C or with calcining in FIGS. 3A-3B.

In some embodiments, the expedited precursor processing (e.g., method or system), shown in FIGS. 2A-2C or FIGS. 3A-3B, can start by dissolving a metallic salt, for example lithium, nickel, manganese, cobalt, or combinations thereof. Metallic salts can include, but are not limited to, acetates, bromides, carbonates, chlorates, chlorides, fluorides, formats, hydroxides, iodides, nitrates, nitrites, oxalates, oxides, perchlorates, sulfates, carboxylates, phosphates, phosphides, nitrides, and oxynitrides. The metallic salts can be dissolved and mixed/stirred in an appropriate solvent such as water (for example deionized water), various alcohols, ethanol, methanol, xylene, organic solvents, or blends of solvents, or alternatively, dispersing insoluble or partially soluble powders in an appropriate medium to form a liquid precursor. In some embodiments, a pH of the liquid precursor can be controlled within a range of 1-14 with metal-free strong acids and bases such as nitric acid or ammonium hydroxide. Solid powder feedstock composed of a solid solution or mixture with a particular overall composition can also be prepared separately and used as a solid feedstock in embodiments of the disclosed process, as shown in FIG. 3B.

The temperature, pH, and composition of the solvent can dictate the amount of metallic salts that can be dissolved in the solvent and therefore the throughput of the process.

The quantity of each salt/solid to be dissolved/dispersed can be calculated to give a desired final stoichiometry of the nickel-manganese-cobalt (NMC) material to be made. As an example, if making NMC 622, the amount of lithium salt would be calculated to yield one mole of lithium, the amount of nickel salt would be calculated to yield 0.6 mole of nickel, the amount of manganese salt would be calculated to yield 0.2 mole of manganese, and the amount of cobalt salt would be calculated to yield 0.2 mole of cobalt in the final NMC 622 product.

In some instances, the amount of any of the salts/solids to be dissolved/dispersed can be increased beyond the theoretical amount calculated. This is because in some instances, lithium, manganese, or other transition metals or constituent elements, may be vaporized and yield less of the metal in the final product than theoretically calculated. Increasing the amount of the salt/solid in the precursor solution/dispersion would make up for the vaporized metal to reach the final desired stoichiometry.

The salt solutions/solid dispersions can be well stirred and filtered if necessary to produce a clean solution free of any sediments. Additive chemicals such as ethanol, citric acid, acetic acid, and others may be added to control morphology, and chemical reactions.

Additional elements can further be added into the solutions (e.g., feedstock material) as dopants as shown in FIG. 2B. However, dopants may not always be used as shown in FIG. 2A. Dopants may or may not be used in the methods shown in FIGS. 3A-3B. The dopant can be made with essentially any element by introducing it into the solutions as a liquid solution, solid solution, or dispersion.

The doping can be achieved by adding a precise proportion of a particular salt containing the desired dopant element into the feedstock material. The final feedstock will be well mixed solution or dispersion of salts of nickel, manganese, cobalt, lithium, and the dopant element(s). After the feedstock is processed by the microwave plasma discussed below, the dopant element(s) are incorporated within the resulting material.

Cationic dopants include, lithium, sodium, magnesium, aluminum, silicon, phosphorous, sulfur, potassium, calcium, scandium, titanium, vanadium, chromium, iron, copper, zinc, gallium, germanium, arsenic, strontium, yttrium, zirconium, niobium, molybdenum, ruthenium, rhodium, palladium, cadmium, indium, cesium, barium, lanthanum, cerium, praseodymium, neodymium, europium, gadolinium, terbium, dysprosium, thulium, lutetium, rhenium, silver, mercury, thallium, lead, bismuth, and combinations thereof. In some embodiments, the dopants can be one or more of aluminum, manganese, zirconium, and titanium. Incorporation of dopants into the NMCs can be simpler than in traditional co-precipitation because the dopants can be added to the starting precursor solution as simple salts and are readily incorporated into the structure during the plasma synthesis.

Aluminum can be particularly advantageous as a dopant for high nickel NMC materials. In some embodiments, the feedstock can be doped with aluminum and another element(s). Co-dopants can include, but are not limited to, Mg, Zr, Ti, Zn, F, P, V, Cr, Nb, and K. Other advantageous dopants can include Zr, Zn, Mg, F, Ti, Cr, V, and P, which can be used with or without aluminum. The dopants can be chosen to improve product life, although improved rate capability is also an advantage of doping. The life improvements may come either by making the surface less reactive or by stabilizing the structure against degradation from cycling.

Once the starting materials are well dissolved or dispersed in the solvent (with or without dopants), the resulting liquid solution precursor can be fed into a droplet maker or an atomizer (nebulizer) to produce droplets that are injected into a microwave generated plasma, though the type of plasma is not limiting and other plasma, such as RF plasma, can be used as well. For example, the resulting precursor can then be transferred into a vessel where it is fed into a droplet maker or an atomizer device that can sit on top of a microwave plasma torch as discussed herein. The precursor droplet solvent can be completely vaporized by the high temperature plasma and react with the oxygen plasma to form oxide materials that condense and form nano or micron sized particles, or be dehydrated more gradually to allow solute precipitation and consolidation, maintaining the solid content of the original droplet, followed by reaction with the plasma gas(es) to form reactant particles. Each droplet goes through a process of solvent evaporation if solvent or hydrates are present, solute precipitation if precipitates form prior to or during reaction, and pyrolysis. The plasma gas is usually chosen to be oxygen, though other gases including but not limited to nitrogen, argon, helium and hydrogen can be used, as well as blends of gases.

The combination of chemically homogeneous and uniformly size-controlled droplet feedstock solution and homogeneous thermal processing provides distinct advantages over conventional solid-state, co-precipitation, and conventional spray pyrolysis processing techniques. In one embodiment of the present disclosure, a homogeneous precursor solution is mixed at the molecular level to ensure equal distribution of starting materials within the solution. The precursor solution is formed into droplets using a droplet maker that can generate one or more streams of droplets having precisely controlled sizes. In some embodiments, the droplet maker can be a piezoelectric droplet maker, such as the droplet maker described in U.S. Pat. No. 9,321,071 and U.S. Patent Publication No. 2016/0228903, each of which are incorporated by reference in their entirety. In one particular embodiment, the droplet maker can control the size of the droplets to a precise diameter with a size distribution of about ±2%. In some embodiments, the droplet maker can include nozzles or openings having different sizes in order to generate streams of droplets having different diameters, which may produce a multi-modal particle size distribution in the end particles. In some embodiments, the droplets may be generated by an atomizer or nebulizer. The droplets of precursor solution can then be axially or radially injected into a plasma as a single stream or several linear streams of droplets.

In an some embodiments, the droplet maker or atomizer device can be positioned to deliver solution precursor droplets radially into the plasma or at an angle between 0° (axial) and 90° (radially) (e.g., 10, 20, 30, 40, 45, 50, 60, 70, or 80°) as to inject the solution precursor droplets in the direction of the plasma gas flows.

In some embodiments, molten precursor salts can be used, and therefore no solvent is needed. Thus, the above approach can be taken but the solvent need not be evaporated or otherwise removed. The molten salt mixture can contain the proper proportions of the Ni, Mn, Co, and Li in the form of nitrates, acetates, other salts or blends of salts. For nitrate precursors in preparing molten salts, the precursors can be melted to between 100° C. and 200° C. (or between about 100° C. and about 200° C.). In some embodiments, they can be heated between 110° C. and 170° C. (or between about 110° C. and about 170° C.). The molten salts can undergo any of the processed disclosed in detail below, though there is no need to dissolve/stir the molten salts. Further, in some embodiments crushing and sieving would not be necessary.

The feedstock material, either liquid or solid, can be introduced into a plasma for processing. U.S. Pat. Pub. No. 2018/0297122, U.S. Pat. No. 8,748,785 B2, and U.S. Pat. No. 9,932,673 B2 disclose certain processing techniques that can be used in the disclosed process, specifically for microwave plasma processing. Accordingly, U.S. Pat. Pub. No. 2018/0297122, U.S. Pat. No. 8,748,785 B2, and U.S. Pat. No. 9,932,673 B2 are incorporated by reference in its entirety and the techniques describes should be considered to be applicable to the feedstock described herein. The plasma can include, for example, an axisymmetric microwave generated plasma and a substantially uniform temperature profile.

In embodiments of the disclosed method, the precursor solvent is completely vaporized due to the high temperature plasma and condenses to form the final product which is a nano-sized to micron-sized powder material depending on starting solution/dispersion formulation and processing conditions. In some embodiments, carrier solvents and/or hydrates are removed to leave the reactants (if necessary) followed by pyrolysis. In some embodiments, the feedstock may not be completely vaporized, and instead may be dried/consolidated, possibly dehydrated and then reacted directly, and/or reacted to form the finished particles.

The residence time of the droplets within the plasma can be controlled, in some embodiments, by controlling the plasma gas flow rate and/or controlling the power density of the microwave generated plasma. In some embodiments, the quenching rate can be adjusted by selecting a different quenching fluid, such as nitrogen, oxygen, or helium. For example, helium can provide a higher quenching rate than other fluids, but may add significant costs to the production process. Different characteristics of the plasma can be adjusted, in some cases, by controlling the plasma process atmosphere, which can include O₂ or various mixtures of oxygen, argon, helium, hydrogen etc.

In some embodiments, an additional step of spray drying, shown in FIG. 2C, can be performed prior to incorporating the material into the plasma. Thus, a solid feedstock can be introduced into the plasma, rather than a liquid, and may not require the use of a droplet maker. A salt solution or dispersion can be spray dried to produce a solid feedstock precursor with particles in the correct size range for the target finished powder. This solid feedstock is produced in the plasma to produce cathode powder. In some embodiments this powder is crystallized during plasma processing, such as in FIGS. 2A-2C. In some embodiments, a post calcination step is used to achieve the desired crystal structure, such as in FIGS. 3A-3B.

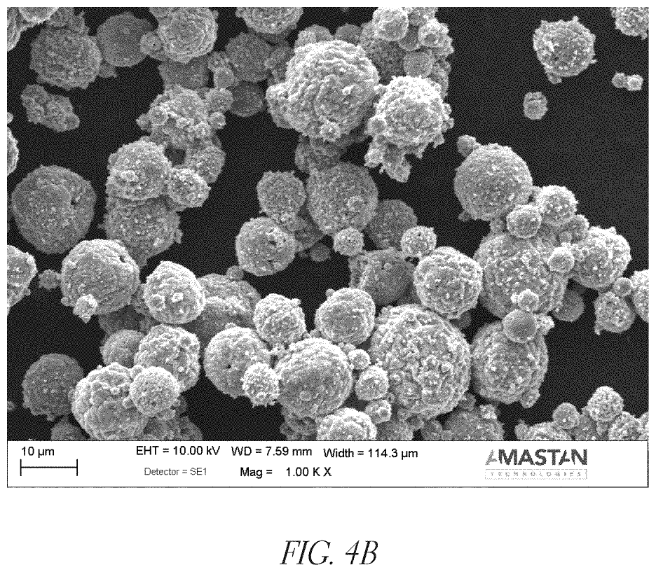

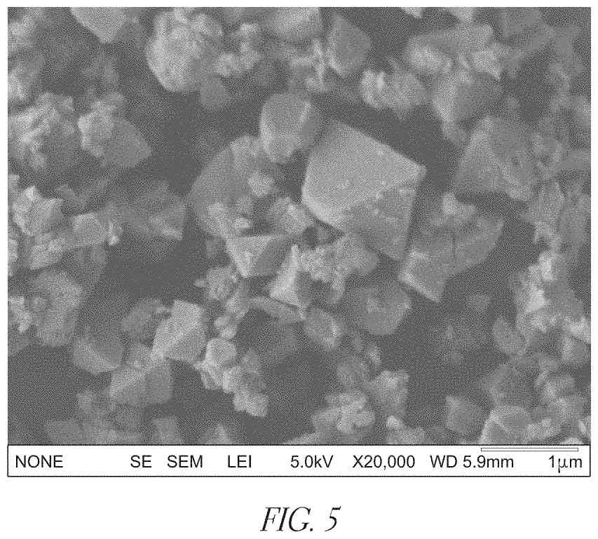

Once plasma processed, the powder material can be nanoparticles or micron sized particles. In some embodiments, the nanoparticles can have a diameter of less than 900, 800, 700, 600, 500, 400, 300, 200, or 100 nm (or less than about 900, about 800, about 700, about 600, about 500, about 400, about 300, about 200 or about 100 nm), as shown in FIG. 4A-4B. In some embodiments, the nanoparticles can have a diameter of greater than 100, 200, 300 or 400 nm (or greater than about 100, about 200, about 300, or about 400 nm). In some embodiments, the micron sized particles can be between 0.5 μm and 50 μm (or between about 0.5 μm and about 50 μm). In some embodiments, the micron sized particles can be between 0.5 μm and 30 μm (or between about 0.5 μm and about 30 μm).

For micron sized particles, in some embodiments, the d50 of the powder particles can be from 5-15 (or about 5-about 15) microns. In some embodiments, the d50 of the powder particles can be from 7-12 (or about 7-about 12) microns. In some embodiments, the d50 of the powder particles can be from 2-3 (or about 2-about 3) microns.

For nano sized particles, in some embodiments, the d50 of the powder particles can be from 200-1000 nm (or about 200-about 1000 nm). In some embodiments, the d50 of the powder particles can be 500 nm (or around 500 nm).

In some embodiments, the powder particles can be formed with a bimodal distribution, having some smaller and some larger particles. In some embodiments, the d50 of the large particles to the small particles can be 10:1 (or about 10:1).

In some embodiments, following the plasma processing, the final NMCs, such as layered NMC crystal structures or NMC particles, are formed. Therefore, no post-processing is needed, such as calcining, which can save significant time in the production of the NMCs, such a layered NMC crystal structure.

The resulting material (e.g., NMCs) from the plasma processing of the solution precursor can be crystalline or amorphous depending on the process conditions. If given enough time in the hot zone, the final particles produced are crystalline. If quenched early, they can be amorphous and further post processing will be required to produce the desired crystalline phase. Specifically, when the plasma length and temperature are sufficient to provide particles with the time and temperature necessary for atoms sufficient time to migrate to their preferred crystallographic locations, then a crystalline material is produced. The length of the plasma can be tuned with parameters such as power, torch diameter, reactor length, gas flow rates, gas flow characteristics and torch type. Amorphous material is produced after the precursor has been fully decomposed into an oxide material and is then cooled quickly enough to prevent atoms reaching their crystallographic positions. Material is cooled by passing it through a high velocity gas stream. The quenching gas may be in the range of −150-40° C. The quenching gas may be in the range of −200-500° C.

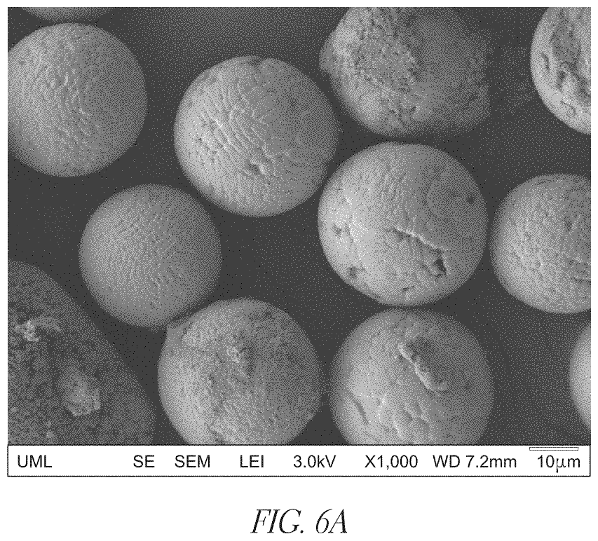

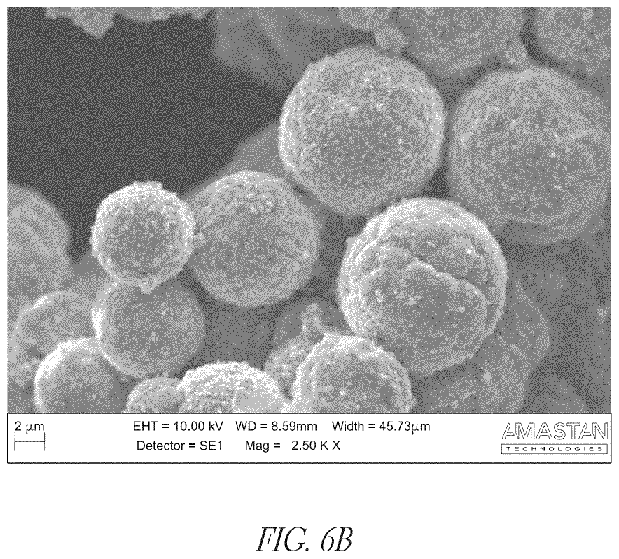

Also, the final particles can be spherical with a tight particle size distribution as shown in FIG. 6A. The particles morphology and surface area can depend on the precursor and chemical additives used in the solution precursor. The NMCs produced using embodiments of the described method can be used as cathode materials in lithium ion battery production. The materials can be cast into a cathode using known battery manufacturing methods. The materials are then tested for electrochemical activity by testing the electrical performance of the battery.

The resulting material from the plasma processing of the solution precursor represents an NMC solid material precursor with particle size in the nano to micron scale. While FIGS. 2A-2C illustrate example methods that do not require any post processing, certain additional procedures can be performed as discussed below. For the methods discussed above with respect to FIGS. 2A-2C, the method can produce a finished electroactive or NMC powder.

In some embodiments, post-plasma processing can be performed as well, adding an additional step to the above disclosed procedures, which can convert a precursor material into a finished electroactive or NMC powder. For example, FIGS. 3A-3B disclose embodiments of an expedited two-step manufacturing process, but can include any or all of the disclosure with respect to FIGS. 2A-2C. In some embodiments, the method does not require one or more of co-precipitation, filtering, or washing/drying, all of which are required in the method of FIG. 1. Further, in embodiments of the disclosure the method does not require lithium to be added to any powder as a separate step requiring subsequent thermal processing. In some embodiments, calcination is not required, though other embodiments may use calcination.

For the “two-step process”, thermal processing post-plasma processing can be performed. However, lithium may not be added during these steps. As shown, the first step can be a plasma pyrolysis step of a solution or solid particulate feedstock material to produce a particulate product (e.g., plasma processing). The second step can be to take the particulate product and calcine it at a particular temperature and time to produce a layered NMC crystal structure (e.g., calcination). FIGS. 3A-3B depict embodiments of a flow diagram of the expedited process to produce the layered NMC crystal structure, which can be completed on a scale of hours. In some embodiments, certain recited process steps in FIGS. 3A-3B can be optional. For example, crushing and sieving may not be necessary for micron scale material, and thus may be optional. Further, spray drying can be performed prior to plasma processing, such as discussed with respect to FIG. 2C.

In some embodiments, shown in FIG. 3B, the product NMC material produced from the plasma processing of the feedstock solution precursor is made into a slurry and then spray-dried to form particles in the desired size range. The slurry may contain water, hydrocarbons, and/or chemical additives to ensure that the spray dry process produces particles with the chosen characteristics. These nano or micron-sized particles constitute the product NMC solid precursor that can be further processed through the traditional route (calcination, classification) to produce layered NMC materials.

Once the particles have been formed as discussed above, they can then be calcined and sieved to produce the layered NMC crystalline structure. As an example, the NMC material can be loaded into crucible(s). The crucibles may be made of alumina, zirconia, etc., but the type of material in is not limiting. The crucibles can be loaded into a controlled atmosphere furnace. Oxygen partial pressure within the furnace can be precisely controlled between 0-100%, such as from 50-100% oxygen. In addition to oxygen, the mixture of gasses may include nitrogen, argon, hydrogen and/or helium. The furnace is ramped to its operation temperature at a rate of 3-30 (or about 3-about 30) degrees C. per minute. The calcination time and temperature can occur, for example, from 1-12 (or about 1-about 12) hrs. at 700-1000 (or about 700-about 1000)° C. The furnace temperature can then be ramped down to room temperature at a rate of 3-30 (or about 3-about 30)° C. per minute. At production scales, the furnace would typically be a continuous furnace such as a pusher furnace/roller hearth kiln or a rotary calciner, with residence times and atmospheres as described above.

FIGS. 6A-6B show SEM pictures of micron scale product NMC powders resulting from calcination of a partially crystallized NMC precursor produced by plasma processing as described herein to produce a fully crystalline NMC powder. As we can see, the material resulting from the plasma process is a spherical powder in the micron scale

Sizing and classification may be done with any or all of the following: air mill classification, ball milling, mech/vibratory sieving, or jet mill classification. An example size distribution can be approximately: d50 of 5-15 um with a d10 of 1-2 um and a d90 of 25-40 um.

Similar to the above discussion, once calcined, the powder material can be nanoparticles or micron sized particles. In some embodiments, the nanoparticles can have a diameter of less than 900, 800, 700, 600, 500, 400, 300, 200, or 100 nm (or less than about 900, about 800, about 700, about 600, about 500, about 400, about 300, about 200 or about 100 nm). In some embodiments, the nanoparticles can have a diameter of greater than 100, 200, 300 or 400 nm (or greater than about 100, about 200, about 300, or about 400 nm). In some embodiments, the micron sized particles can be between 0.5 μm and 50 μm (or between about 0.5 μm and about 50 μm). In some embodiments, the micron sized particles can be between 0.5 μm and 30 μm (or between about 0.5 μm and about 30 μm).

For micron sized particles, in some embodiments, the d50 of the powder particles can be from 5-15 (or about 5-about 15) microns. In some embodiments, the d50 of the powder particles can be from 7-12 (or about 7-about 12) microns. In some embodiments, the d50 of the powder particles can be from 2-3 (or about 2-about 3) microns.

For nano sized particles, in some embodiments, the d50 of the powder particles can be from 200-1000 nm (or about 200-about 1000 nm). In some embodiments, the d50 of the powder particles can be 500 nm (or around 500 nm).

In some embodiments, the powder particles can be formed with a bimodal distribution, having some smaller and some larger particles. In some embodiments, the d50 of the large particles to the small particles can be 10:1 (or about 10:1).

The resulting material (e.g., NMCs) from the calcining can be crystalline or amorphous depending on the process conditions. If given enough time in the hot zone, the final particles produced are crystalline. If quenched early, they can be amorphous and further post processing will be required to produce the desired crystalline phase. Specifically, when the plasma length and temperature are sufficient to provide particles with the time and temperature necessary for atoms sufficient time to migrate to their preferred crystallographic locations, then a crystalline material is produced. The length of the plasma can be tuned with parameters such as power, torch diameter, reactor length, gas flow rates, gas flow characteristics and torch type. Amorphous material is produced after the precursor has been fully decomposed into an oxide material and is then cooled quickly enough to prevent atoms reaching their crystallographic positions. Material is cooled by passing it through a high velocity gas stream. The quenching gas may be in the range of −150-40° C. The quenching gas may be in the range of −200-500° C.

Advantageously, embodiments of the disclosed methods discussed with respect to FIGS. 2A-2C and 3A-3B can be significantly faster than the co-precipitation method used in the art. For example, preparation of the feedstock may take 1-2 hours (or about 1-about 2 hours). The plasma process can add less than 10 seconds (or less than about 10 seconds) with proper continuous harvesting. Calcination can take approximately 1-12 hours (or about 1-about 12 hours). 1-2 hours (or about 1-about 2 hours) may be used for post processing. In total, the processes discussed herein can take 3-17 (or about 3-about 17) hours from feedstock through post processing. However, it can take 1-2 (or about 1-about 2) hours less if post processing is not needed.

Additionally, embodiments of the disclosed process can reduce or avoid contaminants, such as reducing S and Na contamination, because it starts with chemicals that have only the metallic elements needed in the final product (unlike co-precipitation which may contain sodium and sulfur as an example). Thus, embodiments of the disclosure can reduce or eliminate the need for washing to remove synthesis byproducts, such as sulphates and sodium. As an example, if the process is used to make NMCs (thus containing lithium, nickel, manganese, and cobalt), the process can start with nitrates or acetates of lithium, nickel, manganese, and cobalt. In the case of using nitrate-based precursors, the nitrogen from the nitrates may react with oxygen and form NOx, but is not incorporated into the final NMC product. In the case of using acetates, which contain carbon, the carbon will react with the oxygen plasma to form carbon dioxide, which may not be included in the final NMC product. Conversely, co-precipitation starts with sulfates of nickel, manganese, and cobalt and they add sodium hydroxide to the solution, which is not incorporated into the sample. This leads to contaminating the precipitate with sulfur and sodium which must be removed by washing the precipitate.

Accordingly, the material produced through embodiments of the disclosed method can have differences from that of the co-precipitation process known in the art. For example, the solid precursor produced from the plasma process disclosed herein has lithium already incorporated into the material structure at the nano, micron, or molecular level (in some embodiments more than one), whereas the material from co-precipitation method does not have any lithium in it. In this case, lithium is added after co-precipitation as a lithium salt, such as lithium carbonate, and the mixture is then calcined at the right temperature and for the right period of time to allow lithium diffusion into the bulk of the particles resulting in the desired layered α-NaFeO₂-type crystal structure. However, this can require significant calcining time for the Li to diffuse to the core of the particles. Because co-precipitation produces a range of particle sizes in the precursor, this process also has the ability to exert greater control over the particle size distribution by controlling the droplet size of the feedstock material.

### Property Customization

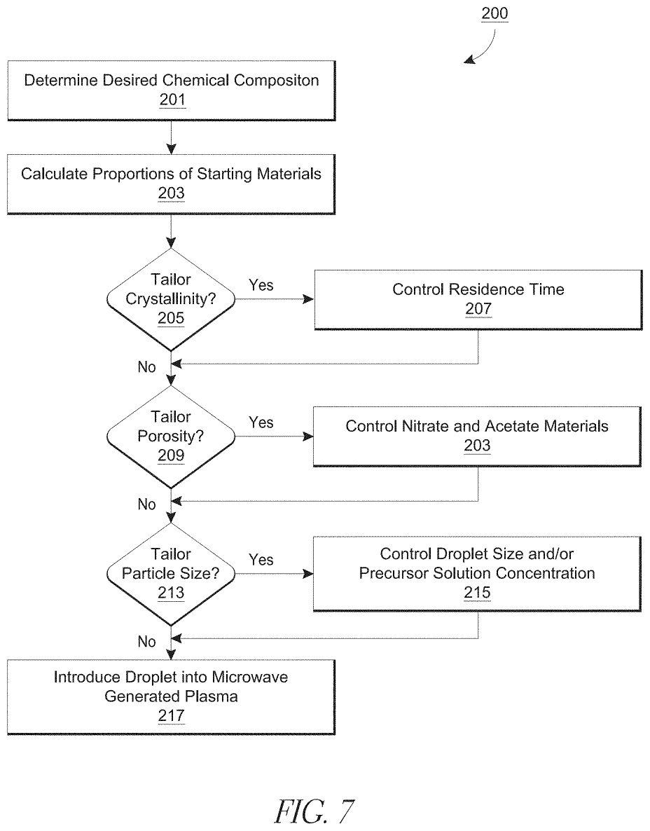

In addition to providing the advantages of much faster processing time (minutes/hours vs. days), embodiments of the present technology allow for the customization or tailoring of various material properties. FIG. 7 is a flow chart 200 of an exemplary method for tailoring Li-ion battery materials, according to an embodiment of the present disclosure. Step 201 involves determining a desired chemical composition of the lithium-containing particles prior to forming the homogeneous precursor solution. In some embodiments, the techniques disclosed herein can be used to produce various lithium-containing particles having different chemical compositions, such as NMC-333, NMC-532, NMC-622, NMC-811. Each of these lithium-containing particles can be produced using acetates, nitrates, hydroxides, carbonates, or other salts/chemicals, or combinations thereof, consistent with the target composition, depending on the desired properties of the end particles. In other embodiments, various chemical compositions of LiₐNiₓCo_{y}Al_{z}O₂ or LiₐNiₓCo_{y}Mn_{z}AlₙO₂ can also be produced. A can be between 0.8 and 1.5. x, y, and z sum to approximately 1, subject to the constraints of charge neutrality. In one embodiment, a=1.0, x=0.8, y=0.15, and z=0.05.

Once the desired chemical composition of the lithium-containing particles is determined, stoichiometric proportions of the starting materials are calculated in step 203. These proportions are based on the desired chemical composition of the end particles, and can be precisely tailored to produce the desired particles. In one example embodiment, in order to produce NMC-333, the starting materials can include 1 mol lithium acetate [Li(COOCH₃)], 0.33 mol nickel acetate tetrahydrate [Ni(COOCH₃)₂*4H₂O], 0.33 mol manganese acetate tetrahydrate [Mn(COOCH₃)₂*4H₂O], and 0.33 mol cobalt acetate tetrahydrate [Co(COOCH₃)₂*4H₂O)]. In another example, the starting materials for producing NMC-333 can include 1 mol lithium nitrate [LiNO₃], 0.33 mol nickel nitrate [Ni(NO₃)₂], 0.33 mol manganese nitrate [Mn(NO₃)₂], and 0.33 mol cobalt nitrate [Co(NO₃)₂]. Different stoichiometric proportions of the starting materials can be calculated in order to produce NMC-532, NMC-622, NMC-811, etc.

Step 205 determines whether the crystal structure of the lithium-containing particles should be tailored. If the crystal structure is to be tailored, the method continues to step 207, where the residence time of the droplets within the microwave generated plasma is controlled in order to tailor the crystal structure of the lithium-containing particles. For example, an amorphous phase can be minimized or eliminated by increasing the residence time at a particular temperature, in some embodiments. The residence time can be tailored, in some embodiments, by controlling the flow velocity of the plasma gas, the power density of the microwave generated plasma, and/or the velocity of the precursor droplets exiting the droplet maker. In some embodiments, a fully or partially crystallized material may be formed. In some embodiments, an amorphous material may be formed.

The method then continues to step 209 to determine whether the porosity of the lithium-containing particles should be tailored. If the porosity is to be tailored, the method continues in step 211 with controlling an amount of nitrate materials and acetate materials within the precursor solution, controlling the solution precursor chemistry, or controlling the residence time of the droplets within the microwave generated plasma. As discussed above, the use of nitrates in the precursor solution can result in more porous lithium-containing particles, while the use of acetates in the precursor solution can result in less or non-porous lithium-containing particles. In some embodiments, non-porous particles can be made with nitrates and without acetates. As will be appreciated, various mixtures and proportions of nitrates and acetates can be used in the precursor solution in order to tailor the lithium-containing particles to a desired porosity.

The method then continues to step 213 to determine whether the particle size of the lithium-containing particles should be tailored. If the particle size is to be tailored, the method continues in step 215 with controlling the droplet size of the droplets of the homogeneous precursor solution or controlling a concentration of the starting materials within the homogeneous precursor solution. For example, if the droplets include an increased concentration of starting materials, the resulting lithium-containing particles will be larger because a larger concentration of solid materials will be available to form the particles once the liquid within the solution evaporates. In some embodiments, various sized lithium-containing particles can be produced in the same process flow by generating different streams of droplets having different sizes. In some embodiments, the particles size can be tailored by entering the droplets of feedstock into the plasma zone, where any carrier solvents and/or bound water are removed and the precursor salt is consolidated into a particle, followed by any reactions with the plasma gases.

The method then continues to step 217 with introducing the droplets into the microwave generated plasma at the desired parameters in order to produce the tailored lithium-containing particles. Once the tailored lithium-containing particles have been produced, they may undergo further processing as discussed above.

### Example Raw Materials and Results

The below Tables 1-2 illustrates some non-limiting example quantities and proportions of starting materials.

TABLE 1
Embodiments of Precursors and NMCs

| Chemical | Formula | NMC-333 | NMC-532 | NMC-622 | NMC 811 |
|---|---|---|---|---|---|
| Li Nitrate | LiNO3 | 153.07 | 143.77 | 143.21 | 142.69 |
| Ni Nitrate | Ni(NO3)2.6H2O | 195.08 | 305.46 | 365.13 | 485.08 |
| Mn Nitrate | Mn(NO3)2.4H2O | 165.55 | 155.52 | 103.28 | 51.45 |
| Co Nitrate | Co(NO3)2.6H2O | 193.93 | 121.46 | 120.99 | 60.27 |
| Solvent | H2O | 293 | 274 | 268 | 261 |
| Total Precursor | | 707.63 | 726.21 | 732.61 | 739.49 |
| in Solution | | | | | |
| Total Solution | | 1000.63 | 1000.21 | 1000.61 | 1000.49 |
| mass (g) | | | | | |
| NMC (g)/L | | 300 g/L | 300 g/L | 300 g/L | 300 g/L |
| solution | | | | | |

TABLE 2
Embodiments of Precursors and Properties

| | | Molar | Molar | Molar | mL for |
|---|---|---|---|---|---|
| Chemical | Solubility | Mass | Solubility | Solubility | NMC-333 |
| Li nitrate | 324 g/100 mL | 52.95 g/mol | 6.12 mol/100 mL | 16.34 mL/mol | 16.34 |
| Ni nitrate | 188 g/100 mL | 182.7 g/mol | 1.03 mol/100 mL | 97.18 mL/mol | 32.36 |
| Mn nitrate | 206 g/100 mL | 178.95 g/mol | 1.15 mol/100 mL | 86.87 mL/mol | 28.93 |
| Co nitrate | 300 g/100 mL | 182.94 g/mol | 1.64 mol/100 mL | 60.98 mL/mol | 20.31 |

As can be seen in Table 1, the precursor solution for generating NMC-333 can include an aqueous solution of 16.34 mL lithium nitrate, 29.15 mL nickel nitrate, 26.06 mL manganese nitrate, and 18.29 mL cobalt nitrate. A list of example precursor solution proportions of lithium nitrate, nickel nitrate, manganese nitrate, and cobalt nitrate for generating NMC-532, NMC-622, and NMC-811 is also provided above in Table 2. One example precursor solution for generating NMC-532 includes an aqueous solution of 16.34 mL of lithium nitrate, 48.59 mL of nickel nitrate, 28.93 mL of manganese nitrate, and 12.20 mL of cobalt nitrate. An example precursor solution for generating NMC-622 includes an aqueous solution of 16.34 mL of lithium nitrate, 58.31 mL of nickel nitrate, 17.37 mL of manganese nitrate, and 12.20 mL of cobalt nitrate. An example precursor solution for generating NMC-811 includes an aqueous solution of about 16.34 mL of lithium nitrate, about 38.87 mL of nickel nitrate, about 2.89 mL of manganese nitrate, and about 1.22 mL of cobalt nitrate.

One of the many advantages of the present technology is the ability to customize the stoichiometry of the lithium-containing battery materials. By changing one or more of the relative proportions, additives, or precursors, one can tailor the composition, purity, and/or phase of a material. In addition, one can easily manufacture more than one composition by simply altering the stoichiometry of the solution precursor (e.g., NMC-532 vs. NMC-622, LiMn₂O₄, LiNi_{0.8}Co_{0.15}Al_{0.05}O₂, LiMn_{1.5}Ni_{0.5}O₄, LiCoO₂, LiNiO₂ etc.) on a single commercial platform, which may or may not have a layered NMC crystal structure. Further, gradients or layers of compositional changes are possible with fluctuations or control over the precursor materials and/or additives, which can result in single or multi crystalline phases. The continuous nature of the processes described in this disclosure allows for a layer-by-layer build-up of the cathode materials such that the chemical composition of each layer can be varied throughout its thickness to exploit the benefits of any desired material. Being a continuous process also eliminates batch-to-batch variations which occur in many conventional battery production techniques. Additionally, the simplicity of the process allows for rapid material development and the exploration of the benefits of new material formulations (e.g., the wide range of NMC formulations and/or the addition of dopants) which may not be possible or cost effective with conventional production techniques.

The NMCs produced using embodiments of the described method can be tested as cathode materials in lithium ion electrochemical cells. The materials are cast into a cathode using known battery manufacturing methods. The materials are then tested for electrochemical activity by testing the electric performance of the battery.

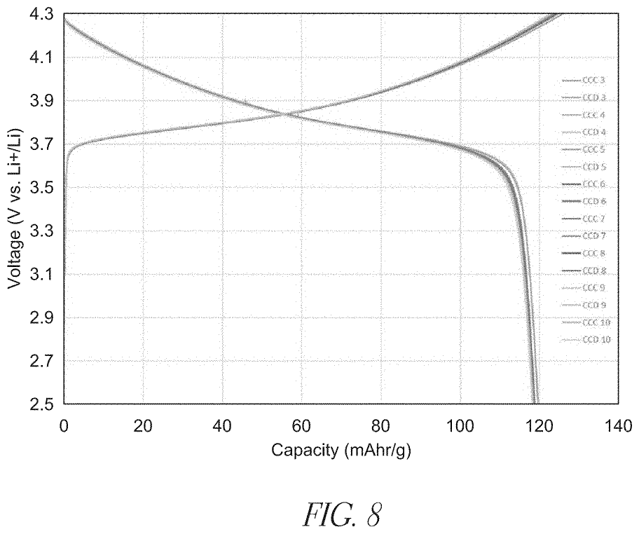

FIG. 8 illustrates electrochemical performance data of NMC 532 produced from embodiments of the above disclosure, showing that the resulting material is functional, and the voltage profile characteristic of this material has been observed. As shown, the material can have 120 mAh/g on discharge

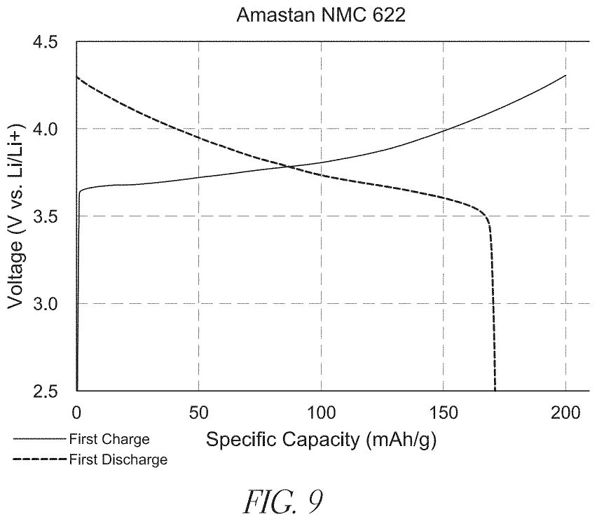

FIG. 9 illustrates electrochemical performance data of NMC 622 produced from embodiments of the above disclosure, showing that the resulting material is functional, and the voltage profile characteristic of this material has been observed. In particular, a first charge capacity of 200 mAh/g is achieved (4.3V versus Li), with reversible capacity >170 mAh/g, comparable to commercially available materials.

Some advantages of the disclosed methods are reduced cost, minimized byproduct waste streams, processability due to controlled morphology, increased packing density in the cathode electrode for higher energy density in the final energy storage device, and tailored rate (power) capability via engineered porosity for high rate applications.

### Powder Products

According to the techniques described in this disclosure, lithium-containing particles can be produced using a shortened process that can be completed in hours rather than days. Not only is the process for generating lithium-containing particles significantly simplified and accelerated, the end products can be significantly more uniform in size, and porosity, morphology, and chemical composition can be precisely tailored. The techniques described herein may be used to produce cathode, anode, or solid electrolyte materials for lithium-based batteries. Exemplary materials for use in one or more of the cathode, anode, and electrolyte include, but are by no means limited to: LiNiₓMn_{y}Co_{z}O₂, LiNiₓCo_{y}Al_{z}O₂, LiMnₓO_{y}, LiMnₓCo_{y}O_{z}, LiFePO₄, LiCoPO₄, LiMnPO₄, Li(FeₓMn_{y})PO₄, Li₈ZrO₆, Li₂FeMn₃O₈, Li₄Ti₅O₁₂, SnO₂, Co₉S₈, LiVP₂O₇, NaLaTi₂O₆, LiₓPO_{y}N_{z}, Li garnet, and Li₁₀GeP₂O₁₂.

In some embodiments, the techniques described herein can be used to produce lithium-containing materials, such as LiNiₓMn_{y}Co_{z}O₂ (where x≥0, y≥0, z≥0, and x+y+z=1) and LiNiₓCo_{y}Al_{z}O₂ (where x=˜0.8, y=˜0.15, z=˜0.05) positive cathode powders in a minimized processing step. For example, LiNi_{0.5}Mn_{0.3}Co_{0.2}O₂ (NMC-532), LiNi_{0.6}Mn_{0.2}Co_{0.2}O₂ (NMC-622), or LiNi_{0.8}Mn_{0.1}Co_{0.1}O₂(NMC-811) can be produced by providing different proportions of lithium, nickel, manganese, and cobalt salts to the precursor solution.

In some embodiments, LiNi_{1/3}Mn_{1/3}Co_{1/3}O₂ (NMC-333) can be produced using a precursor solution that includes an aqueous solution of 1 mol lithium acetate [Li(COOCH₃)], 0.33 mol of nickel acetate tetrahydrate [Ni(COOCH₃)₂*4H₂O], 0.33 mol manganese acetate tetrahydrate [Mn(COOCH₃)₂*4H₂O], and 0.33 mol cobalt acetate tetrahydrate [Co(COOCH₃)₂*4H₂O)]. This precursor solution is mixed into a homogeneous solution and formed into droplets with controlled size using a droplet maker, as described above. The droplets of the precursor solution can then be introduced axially to a microwave generated plasma, where the liquid is evaporated, the acetates decompose, and the remaining transition-metal cations react with the oxygen-containing plasma to yield spherical ceramic particles of the desired stoichiometry.

As mentioned above, layered NMC crystals can be formed. The layered NMC crystal structure is defined as the α-NaFeO₂ crystal structure with alternating atomic layers of lithium and transition metal oxides. The resulting layered NMC materials may be single crystal primary grains in a range of 3-20 (or about 3-about 20) microns. In some embodiments, the grain size can be in the range of 0.5 microns-20 microns (or about 0.5 microns-about 20 microns). In some embodiments, the grain size can be in the range of 0.1 microns-20 microns (or about 0.1 microns-about 20 microns). The resulting layered NMC materials may be irregular in shape, or spherical in shape depending on the particular embodiment. Resulting particles may possess surface area in a range of 0.1-10 m²/g (or about 0.1-about 10 m²/g). In some embodiments, resulting particles may possess surface area in a range of 0.01-10 m²/g (or about 0.01-about 10 m²/g). FIG. 5 shows an SEM picture of a single crystal NMC 811.

Some advantages of the disclosed embodiments include the ability to tailor the precursor chemistry and particle morphology without complex, less controlled co-precipitation methods (leading to significantly lower conversion costs); use of the plasma system also enables the use of precursor materials that are impractical or impossible to utilize in conventional calcining operations, due to e.g. low temperature melt transitions as in the case of certain salt precursors. The process also allows the incorporation of the Li-content at the nano, micro, or molecular scale (in some embodiments more than one) in the feedstock, as opposed to adding at the calcining step as is done with conventional co-precipitation precursors, which in term necessitates long calcining times to achieve uniform Li distribution within the particles.

For example, NMCs formed from embodiments of the disclosure can exhibit novel morphological characteristics not seen in traditionally made NMCs. These morphological characteristics include dense/non-porous particles for maximum energy density, network porosity to enable fast ion transport in the liquid phase for high power applications, and engineered particle size and surface produced in a single processing step.

In some embodiments, the network porosity of the NMCs can range from 0-50% (or from about 0 to about 50%). The particle size can be, for example, between 1-50 micron (or between about 1-about 50 micron). Additionally, a composition at the surface of the NMCs can be made different either in terms of the ratios of the primary constituents (Ni, Mn, and Co) or can be a different material entirely. For example, alumina can be used to passivate the surface.

Embodiments of the disclosed methodology also can give precise control over particle size and particle size distribution, which can be used to maximize particle packing for improved energy density. Engineered interconnected internal porosity can be created with the proper selection of starting materials and process conditions, allowing electrolyte access to the interior and thus decreasing max solid-state diffusion distances, increasing rate capability of the resulting electrochemical cell.

Generally, engineered interconnected internal porosity can be defined as empty space within the NMC material exhibiting an open path through the particle surface. This is different than closed porosity where the empty space within a particle does not exhibit and open path through the particle surface. In some embodiments, closed porosity may not be desirable, whereas interconnected open porosity could be advantageous for high power applications.

Moreover, NMCs formed by embodiments of the disclosure may also exhibit well controlled size and size distribution, of what is known in the industry as secondary grain size, ranging from 1-150 microns (or about 1-about 150 microns)+/−10% (or +/−about 10%).

In some embodiments, the size distribution can be a d50 of 5-15 μm (or about 5-about 15 μm). In some embodiments, the particles can have d10 of 2 μm (or about 2 μm) and a d90 of 25 μm (or about 25 μm). However, other distributions may be advantageous for specific applications. For example, larger particles, though still in the range of <50 μm d50 (or <about 50 μm) can be advantageous for very low power energy storage applications. Further, smaller particles, such as 2-5 μm d50 (or about 2-about 5 μm) or 0.5-5 μm d50 (or about 0.5-about 5 μm) can be advantageous for very high-power applications.

Additionally, the primary grain size for the NMCs can be modified to be from 10 nm-10 microns (or about 10 nm-about 10 microns). In some embodiments, the primary grain size may be between 100 nm and 10 microns (or between about 100 nm and about 10 microns). In some embodiments, the primary grain size may be between 50 and 500 nm (or between about 50 and about 500 nm). In some embodiments, the primary grain size may be between 100 and 500 nm (or between about 100 and about 500 nm).

The surface area of the NMC material can be controlled by both material porosity and particle size distribution. For example, assuming an identical particle size distribution, an increase in either surface or network porosity leads to an increase in surface area. Similarly, when keeping the level of porosity identical, smaller particles will yield a higher surface area. The surface area of NMC material can be tuned within a range of 0.01-15 m²/g (or about 0.1-about 15 m²/g). In some embodiments, the surface area of NMC material can be tuned within a range of 0.01-15 m²/g (or about 0.01-about 15 m²/g). Further, the final particle size can be approximately: d50 of 5-15; d10 of 1-2 um; d90 of 25-40 um. In some embodiments, the d50 can be 2-5 microns (or about 2-about 5 microns). In some embodiments, the d50 can be 0.5-5 microns (or about 0.5-about 5 microns). Porosity can be modified to tailor the surface area within the desired range.

Material specific surface area, in part, plays a large role in the power capabilities of a battery. Batteries with a high-power requirement may require a high surface area cathode material, while batteries with a low power requirement will benefit from lower surface area, because while beneficial for power, high surface can negatively affect processing, final energy density, gassing/cycle life, and safety.

Stoichiometry of the material can be controlled by altering the concentration of constituents within the feedstock material. NMC material can be made for all stoichiometries defined by the following: NMC=LiₐNiₓCo_{y}Mn_{z}M1_{d1}M2_{d2} . . . Mn_{dn}O₂ where a=0.8-1.5; M1=cationic dopant #1, M2=cationic dopant #2 . . . Mn=cationic dopant # n; d1=concentration of dopant #1, d2=concentration of dopant #2 . . . dn=concentration of dopant n; quantities of each element to be constrained by the requirements of charge neutrality.

Advantages of the disclosed methods include a lower cost NMC product with improved processability due to controlled morphology, better packing in the cathode electrode for higher energy density in the final energy storage device by tailoring the particle size distribution, and tailored rate capability via engineered porosity for high rate applications.

“Better packing” implies reduced open space between NMC particles within an electrode (e.g., minimizing dead space not used to store energy). This results in more capacity (and thus energy) stored per unit volume, thus the energy density of the electrode and associated device is increased. The distribution of particle sizes can affect the packing that can be achieved by the particles in a finished electrode as well as the forces required to achieve a given density during electrode processing, Engineering the particle size distribution to be, for example, bimodal can significantly improve the ability to pack the particles to high density (e.g., low porosity in the electrode, for maximum energy density.)

Rate capability is a term for the power the cell can deliver; a “high rate” cell or material can deliver high power, but generally this comes with a low energy density (as power capability goes up, energy density goes down). Other things being equal, smaller particles and less energy dense designs are used to achieve high power; because of our control over particle size and porosity, the material can be optimized for either high rate (fine particles and/or connected open porosity) or high energy density (larger dense particles optimized for maximum packing density.)

According to some embodiments, the techniques and systems described in this disclosure can be used to create core-shell structures, such as carbon coated particles (e.g., lithium-containing particles coated with carbon). Other coatings or shells, such as alumina coatings, can also be produced using the techniques described herein. In other embodiments, different types of battery materials can be coated or layered onto a substrate, such as the current collector of a battery. These materials can be deposited in discrete layers having desired thicknesses, or as a continuously graded coating where the material composition of the coating gradually changes throughout the thickness of the coating. These different materials can be deposited by controlling the composition of the initial precursor solution, in some embodiments.

From the foregoing description, it will be appreciated that inventive processing methods for lithium ion battery solid precursors are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A method of preparing cathode powders for use in a cathode of a lithium ion cell, the method comprising:
providing raw materials of metallic salts comprising lithium dissolved in a solvent;
mixing the raw materials to form a feedstock material; and
plasma processing the material to produce a micron or smaller sized solid powder, the solid powder having all of NMC constituent materials;
wherein no thermal post-processing is performed after the plasma processing.

2. The method of claim 1, further comprising adding a dopant material into the raw materials, wherein the dopant material is selected from the group consisting of Al, Mg, Zr, and Ti.

3. The method of claim 1, wherein the solid powder comprises particles having a d50 diameter of less than 500 nm.

4. The method of claim 1, wherein the solid powder comprises particles having a d50 diameter of between 0.5 μm and 30 μm.

5. The method of claim 1, wherein the metallic salts further include cobalt, nickel, manganese, aluminum, and combinations thereof.

6. The method of claim 1, wherein the plasma processing is microwave plasma processing.

7. The method of claim 1, wherein the method does not use co-precipitation and wherein lithium is not added into the solid powder after the plasma processing.

8. The method of claim 1, wherein the method takes under 6 hours.

9. A method of preparing powders for use in a cathode of a lithium ion cell, the method comprising:
providing raw materials of metallic salts comprising lithium dissolved in a solvent;
mixing the raw materials to form a feedstock material;
plasma processing the feedstock material to produce a NMC precursor powder; and
calcining the NMC precursor powder to form calcined NMC powder;
wherein lithium is not added during the calcining.

10. The method of claim 9, wherein the calcining occurs from 1-12 hours at a temperature of 700-1000° C.

11. The method of claim 9, wherein the calcined NMC powder comprises particles having a d50 diameter of less than 500 nm.

12. The method of claim 9, wherein the calcined NMC powder comprises particles having a d50 diameter of between 0.5 μm and 30 μm.

13. The method of claim 9, wherein the metallic salts further include cobalt, nickel, manganese, aluminum, and combinations thereof.

14. The method of claim 9, wherein the plasma processing is microwave plasma processing.

15. The method of claim 9, wherein the method does not use co-precipitation and wherein lithium is not added into the NMC precursor powder after the plasma processing.

16. The method of claim 9, wherein the method takes under 10 hours.

17. A method of preparing powders for use in a cathode of a lithium ion cell, the method comprising:
providing molten metallic salts comprising lithium; and
plasma processing the molten metallic salts to produce a micron or smaller sized solid powder, the solid powder having all of NMC constituent materials;
wherein no thermal post-processing is performed after the plasma processing.

18. The method of claim 17, wherein the plasma processing is microwave plasma processing.

19. The method of claim 17, wherein the method does not use co-precipitation and wherein lithium is not added into the solid powder after the plasma processing.

20. The method of claim 17, wherein the method takes under 6 hours.
